(19) United States
(12) Patent Application Publication
(10) Pub. No.: US 2016/0179985 A1
(43) Pub. Date: Jun. 23, 2016

(54) MANIFOLD GENERATOR

(71) Applicant: BIFOLD FLUIDPOWER LIMITED, Manchester (GB)

(72) Inventors: Michael James Dowman, Leeds (GB); Nicholas Paul Whitehead, Manchester (GB)

(73) Assignee: Bifold Fluidpower Limited, Manchester (GB)

(21) Appl. No.: 14/908,799

(22) PCT Filed: Jul. 18, 2014
(86) PCT No.: PCT/EP2014/065546

§ 371 Date: Jan. 29, 2016

(30) Foreign Application Priority Data
Jul. 30, 2013 (GB) 1313602.3

(51) Int. Cl. G06F 17/50

(52) U.S. Cl. CPC G06F 17/50

(57) ABSTRACT

A computer implemented method of generating a model of a composite product comprising a plurality of modules. The method comprises receiving a schematic comprising a plurality of schematic symbols, each schematic symbol representing a respective module and processing each schematic symbol in turn. The processing of each schematic symbol comprises determining a module represented by the schematic symbol, determining one or more module requirements for the module represented by the schematic symbol and adding a representation of the module to a model in accordance with the module requirements.

The present invention relates to methods for generating models of composite products, such as but not limited to, manifolds for fluid regulation.

Products may be made up of a number of functional modules together with additional components not directly related to the function of the product. Such products may be referred to as a composite product. For example, as a manifold for fluid regulation may be made up of a number of functional components such as valves, exhausts, ports, etc for performing the function of regulating fluid flow. Additionally, a manifold may also comprise components such as tie-rods, spacers, etc, not directly related to the regulation of fluid flow. As such, products such as manifolds often comprise a very large number of constituent parts.

It is known to use computers to create models of composite products together with, or in place of, creating physical prototypes. For example, computer aided design (CAD) may be used to generate 3D representations of products. The generation of such models often requires a detailed knowledge of complex software, and an ability to use that software to specify and model the large number of constituent parts that may be present in a complex product such as a manifold.

It is an object of the present invention to obviate or mitigate one or more problems with the prior art whether identified herein or elsewhere.

According to a first aspect described herein, there is provided a computer implemented method of generating a model of a composite product comprising a plurality of modules. The method comprises, receiving a schematic comprising a plurality of schematic symbols, each schematic symbol representing a respective module and processing each schematic symbol in turn. The processing of each schematic symbol comprises: determining a module represented by the schematic symbol; determining one or more module requirements for the module represented by the schematic symbol; and adding a representation of the module to a model in accordance with the module requirements.

In this way, a model of a composite product can be generated from a relatively simple schematic, without the schematic needing to specify module requirements necessary to allow the module to be added to the model. Such a schematic could be generated by someone without the specialist knowledge required to generate a model based on the module requirements. For example, each schematic symbol may simply indicate a functional module of the composite product, such that a person generating the schematic need only understand the functionality that the composite product should achieve. Further, models may be generated more quickly and efficiently, as it is unnecessary to specify each of the module requirements in the schematic. Further, where the specifications of modules change, the schematics required to generate those models according to the first aspect need not change. As such, new knowledge is not required for the generation of schematics when changes to modules occur.

The modules may be adjacent one another. Determining one or more module requirements for at least some of the schematic symbols may comprise determining module requirements relating to an adjacent module. In this way, requirements for placement of one module next to another module need not be specified in the schematic, thereby increasing the speed, ease and accuracy with which schematics, and therefore models, can be generated.

Determining one or more module requirements may comprise determining a spacing requirement indicating a spacing required between the module and another module. The method may further comprise adding a representation of a spacer component to the model between the module and the another module in dependence upon the determined spacing requirement. In this way, the schematic need not specify the spacings between modules nor specify whether there are any spacing components to provide the required spacings. This again can improve the speed, ease and accuracy with which models can be generated, while ensuring that the same schematic can be used to generate a model in the event that a spacing required between two modules increases.

Determining a spacing between the module and another module may comprise determining an amount by which a part of the module extends into a space that may be occupied by a part of the another module and determining an amount by which a part of the another module extends into a space that may be occupied by the module.

Determining one or more module requirements may comprise determining one or more first components required in combination with the module. Adding a representation of the module to the model further comprises adding representations of said one or more first components to the model. In this way not all components that are required to model the composite product need be specified in the schematic. For example, the components may comprise non-functional components such as, in the case of a manifold, tie-rods, ports, exhausts, brackets, etc.

The representation of the module may comprise data indicating physical characteristics of the module. For example, data comprising physical characteristics of the module may comprise a 3D graphical representation of the module. The method may comprise outputting a 3D graphical representation of the composite product. In this way, a simple schematic can be used to output a 3D graphical representation of the composite product without a need for the creator of the schematic to understand or use software capable of creating the 3D graphical representation directly.

The method may further comprise determining one or more second components required in the composite product as a result of at least one of the modules represented in the model. The method may comprise adding a representation of the one or more second components to the model. For example, after each component has been added to the model, components such as tie-rods may be added to the model, the length of the tie-rods depending upon the number and size of both the modules and any other components added to the model.

Each schematic symbol may comprise a respective symbol identifier. Determining a module represented by a schematic symbol may comprise obtaining a module identifier associated with the symbol identifier. Determining one or more module requirements for the module represented by the schematic symbol may comprise determining one or more module requirements stored in a database and associated with the module identifier.

Obtaining a module identifier associated with the symbol identifier may comprise determining an orientation of the schematic symbol. In this way, the same schematic symbol may relate to different module IDs and/or different module requirements, thereby reducing the number of schematic symbols and/or schematic IDs required to reference the respective modules.

The composite product may be a manifold.

According to a second aspect described herein, there is provided an apparatus for generating a model of a composite product comprising a plurality of modules. The apparatus of the second aspect comprises a receiver arranged to receive a schematic comprising a plurality of schematic symbols, each schematic symbol representing a respective module, a processor arranged to process each schematic symbol in turn. The processing of each schematic symbol in turn is arranged to determine a module represented by the schematic symbol, determine one or more module requirements for the module represented by the schematic symbol; and to add a representation of the module to a model in accordance with the module requirements.

According to a third aspect, there is provided a computer implemented method comprising at a first computer providing a web-based application to a client computer over a network. The web-based application provides a user interface which is configured to receive a selection from a plurality of schematic symbols each schematic symbol representing one of a plurality of modules. The user interface is further configured to receive indications of associations between the selected schematic symbols.

In this way, there is provided a way in which a user can easily generate a schematic of a composite product. The third aspect provides a method by which a user may, for example, generate a schematic for use with the first and/or second aspect.

The schematic symbols may each represent a respective functional module of the composite product. The user interface may be configured such that a user of the client computer need not specify other, non-functional, components of the composite product.

The user interface may allow the selected schematic symbols to be defined in relation to schematic symbols already selected. For example, where the composite product is a manifold, the user interface may be configured to receive selection of a plurality of schematic symbols representing inline modules starting with a schematic symbol representing a left-most inline module and proceeding by receiving a selection of a schematic symbol representing an inline module to the right of the inline module represented by the previously received schematic symbol. The user interface may further be configured to receive a selection of a plurality of stacker modules for placement above at least one of the inline modules, starting with a first schematic symbol representing a first stacker module and proceeding to receive schematic symbols representing stacker modules to be placed above a stacker module represented by the previously received schematic symbol.

The user interface may be configured to display a schematic and to indicate positions at which one or more further schematic symbols may be validly added to a schematic.

The method may further comprise, at the client computer receiving at the user interface from the user a selection from the plurality of schematic symbols, receiving at the user interface from the user indications of associations between the selected schematic symbols, and generating a schematic representing a composite product based on the received selection and the received indications.

The method may further comprise transmitting the schematic to a computer configured to carry out a method according to the first aspect. The computer configured to carry out a method according to the first aspect may be the computer configured to provide the web-application or may be a different computer. The computer configured to carry out a method according to the first aspect may be an apparatus according to the second aspect.

According to a fourth aspect described herein, there is provided a computer apparatus for generating a model of a composite product comprising a plurality of modules, comprising a memory storing processor readable instructions; and a processor arranged to read and execute instructions stored in said memory; wherein the processor readable instructions comprise instructions configured to cause the processor to carry out a method according to the first or third aspects.

According to a fifth aspect described, there is provided a computer program comprising computer readable instructions arranged to cause a computer to carry out a method according to the first or third aspects. The computer program may be carried on a computer readable medium. The computer readable medium may be tangible or intangible.

Aspects of the invention can be implemented in any convenient form including by way of suitable methods, systems and apparatus. Aspects of the invention can be implemented by way of a computer. As such computer-implemented methods in which each step is carried out by a suitably programmed processor are provided. Similarly, aspects of the invention provide computer readable media comprising computer executable instructions configured to cause a computer to carry out a method as described above. Such computer readable media include tangible media (e.g. discs) and intangible media (e.g. communications signals). Further aspects of the invention provide computer readable media storing a representation of graphical data such as a graphical representation of a schematic or a graphical representation of a model generated using methods as described above.

It will also be appreciated that features presented in the context of one aspect of the invention in the preceding and following description can equally be applied to other aspects of the invention.

Where aspects of the invention are implemented by way of a computer, there may be provided a computer apparatus comprising a memory (e.g. a random access memory) storing processor readable instructions and a processor configured to read and execute instructions stored in said memory. The processor readable instructions may comprise instructions configured to cause the processor to carry out a method as set out above.

An embodiment of the invention will now be described, by way of example, with reference to the accompanying drawings, in which:

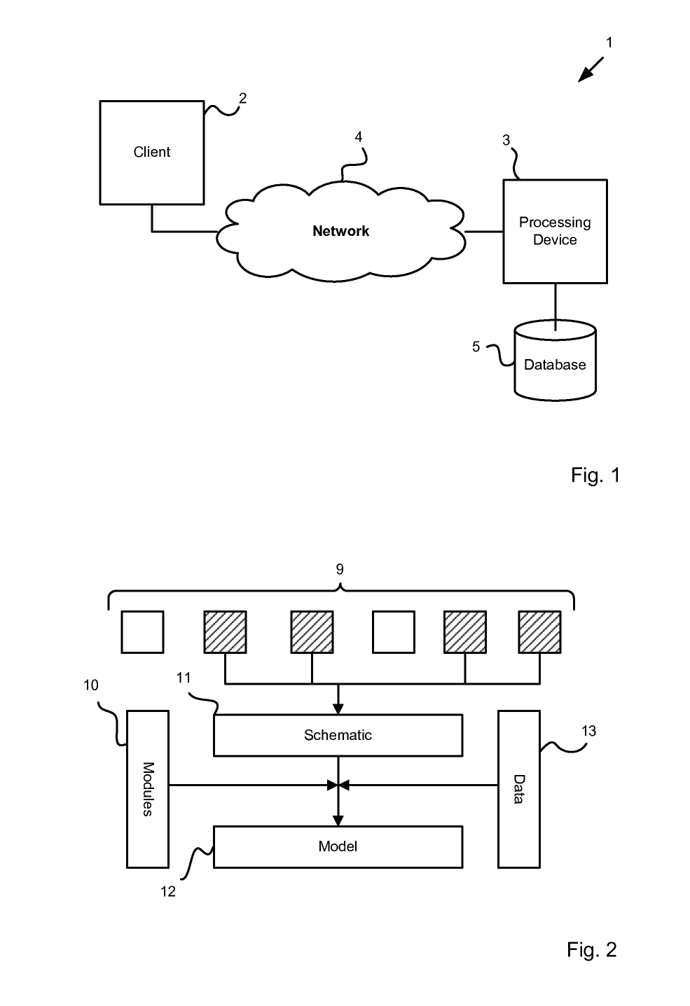

FIG. 1 is a schematic illustration of a network of devices in accordance with an embodiment described herein;

FIG. 2 is a schematic representation of components used in the generation of a model of a composite product in accordance with an embodiment described herein;

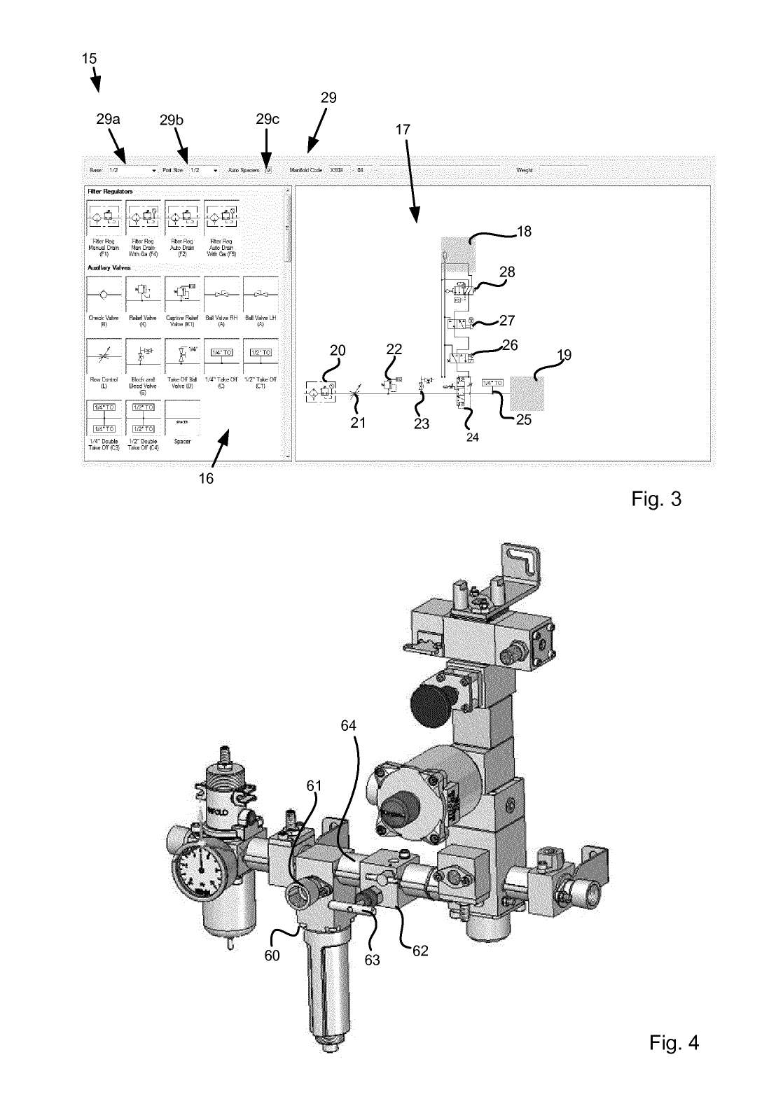

FIG. 3 is a representation of a user interface for generating a schematic of a composite product;

FIG. 4 is an image of a 3D model generated using an embodiment described herein;

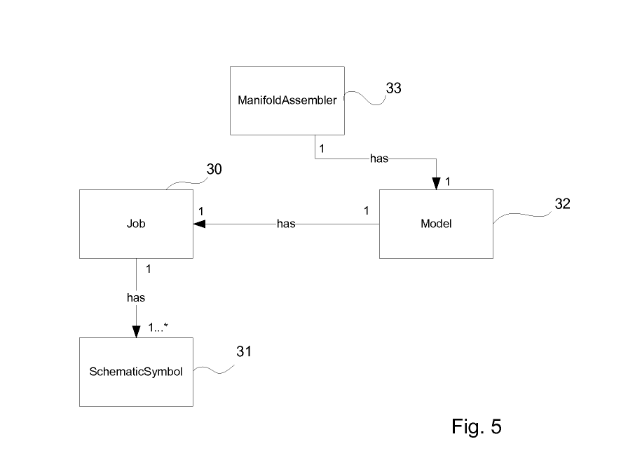

FIG. 5 is a schematic representation of classes used by a program operable to generate a model of a composite product from a schematic in an embodiment described herein;

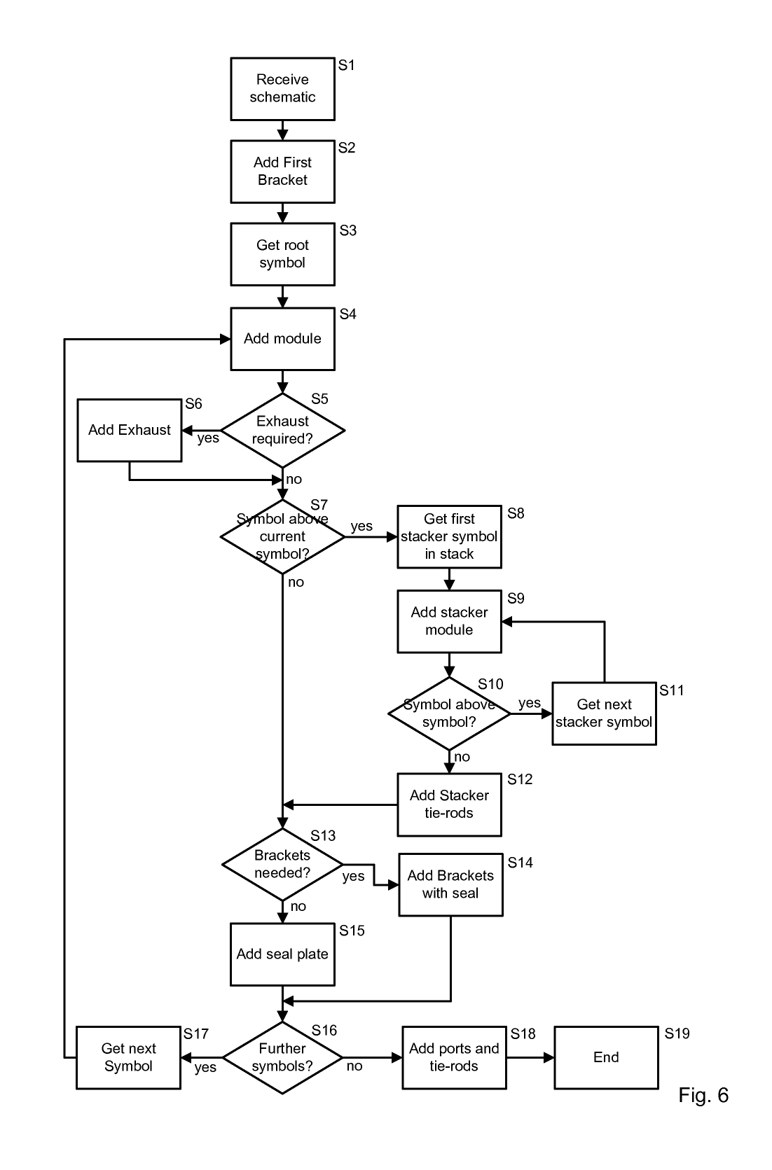

FIG. 6 is a flowchart showing example processing carried out by a processing device of FIG. 1 to generate a model in an embodiment described herein;

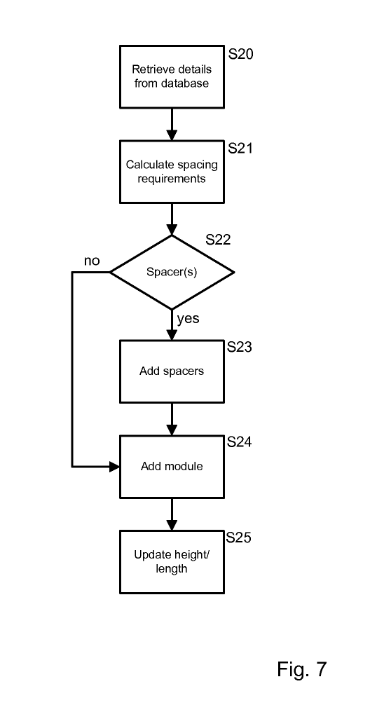

FIG. 7 is a flowchart showing example processing carried out by the processing device of FIG. 1 to select a module during the processing of FIG. 6;

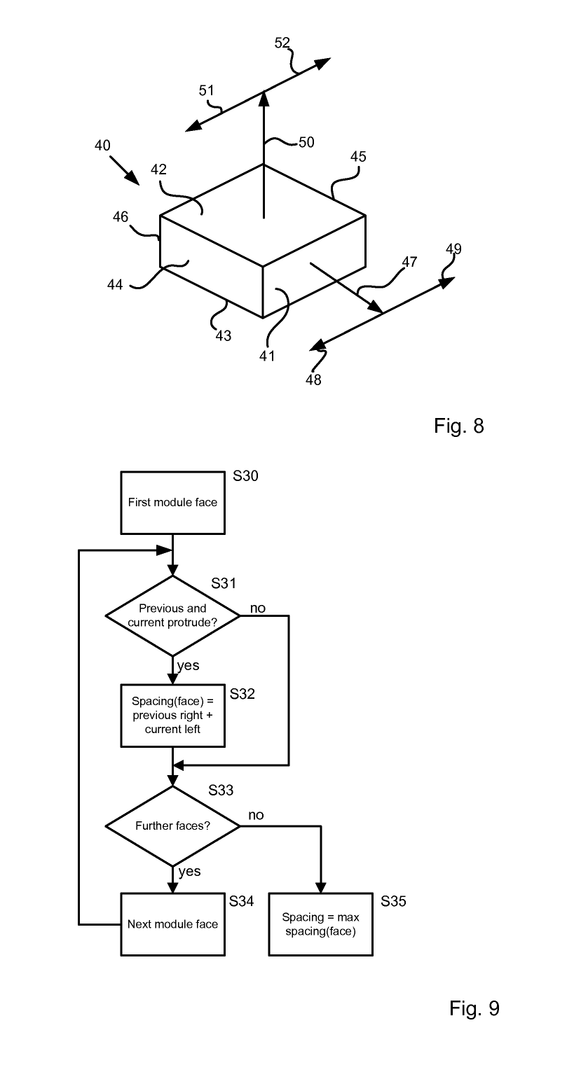

FIG. 8 is a schematic representation of example data representing physical characteristics of a module;

FIG. 9 is a flowchart showing example processing to calculate a spacing requirement in the processing of FIG. 8;

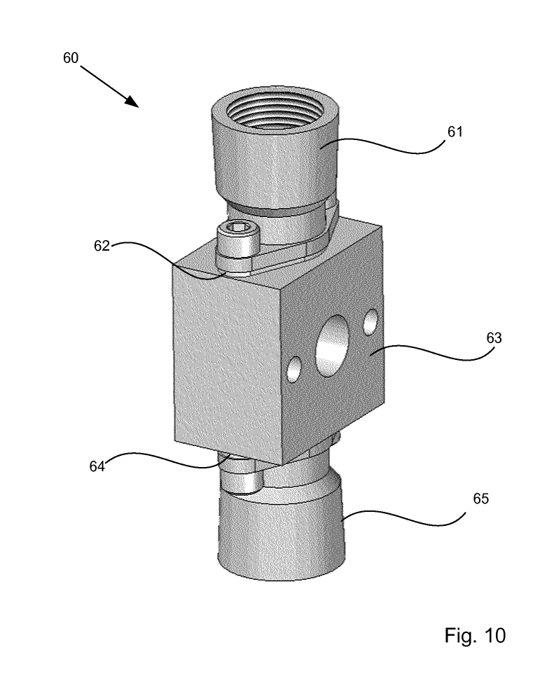

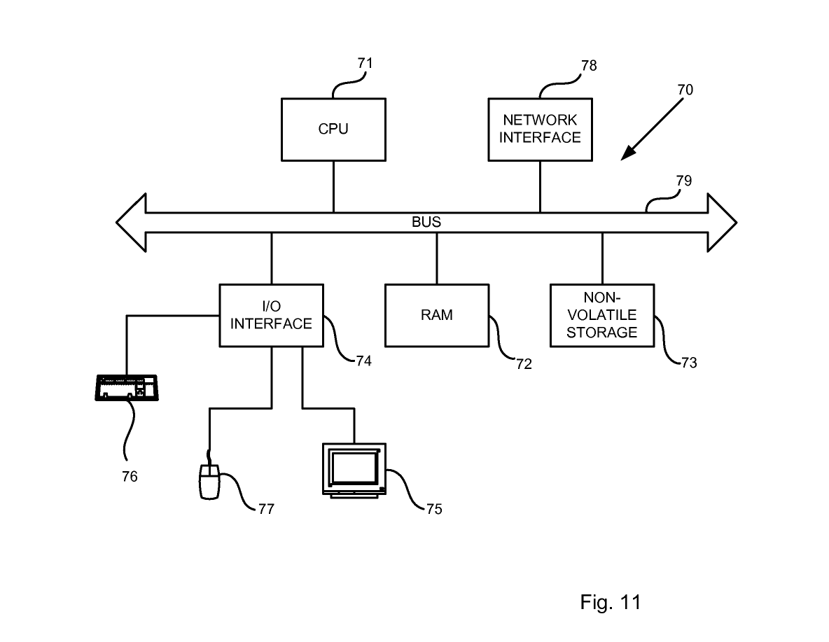

FIG. 10 is a schematic representation of an example module that may form part of a composite product; and

FIG. 11 is a schematic representation of components that may be used to provide a processing device of FIG. 1.

Referring to FIG. 1, there is illustrated a system 1 suitable for implementing some embodiments of the present invention. The system 1 comprises a client device 2 arranged to connect to a processing device 3 via a network 4. The network 4 may be any network, and may be, for example, the Internet. The processing device 3 connects to a database 5 storing data used by the processing device 3. The processing device 3 may be, for example, a computer arranged to act as a server. For example, the processing device 3 may provide functionality such as a web-server and an application server.

The client device 2 is operable to execute a computer program, the computer program providing functionality that allows a user of the client device 2 to create a schematic representation of a product such as a manifold for regulating fluid flows, which is made up of a plurality of modules, through the selection of a plurality of schematic symbols, each schematic symbol representing a respective module. For example, the computer program may be a web-browser configured to access a web-based application that provides the functionality. For example, the web-based application may be provided by the processing device 3 over the network 4.

Alternatively, the computer program may be a computer program stored locally to the client device 2. It will be appreciated that the term web-based application is intended to refer to a computer application that is accessed over a network such as the Internet or an Intranet. Where the computer program is stored locally, the computer program may nonetheless be accessed via a web-browser (i.e. the computer program may comprise computer program code written in a browser-supported programming language such as JavaScript).

With reference to FIG. 2, there is schematically shown a plurality of schematic symbols 9 which can be selected by a user for inclusion within a schematic of a composite product such as a manifold. In particular, a user selects from among the plurality of schematic symbols 9 to create a schematic 11 representing a composite product to be modelled. As will become apparent from the description herein, the schematic 11 need not comprise a representation of every part within the composite product. Upon selection of the schematic symbols 9, the schematic 11 is sent, via the network 4, to the processing device 3. The processing device 3 is configured to process the received schematic 11 to generate a model 12 of the composite product, the model 12 providing an accurate representation of the composite product to facilitate modelling and creation of the composite product. The model 12 may be, for example, a CAD model.

In generating the model 12, the processing device 3 selects from a plurality of modules 10 represented by the selected schematic symbols, details of which are stored in the database 5. The processing device 3 further utilises data 13 stored in the database 5 associated with each module to determine requirements for using the modules 10 within the model 12. The database 5 therefore provides data that allows appropriate modules to be identified from the information within the schematic 11, and any information required to allow that module to be used within the model 12. For example, the data 13 may comprise indications of the physical characteristics of each module. The data indicating physical characteristics may comprise a graphical representation of the module (or a location at which a graphical representation is stored). The data 13 may further comprise an orientation of the module, offsets with respect to other modules, and any other data required to accurately model the module within the composite product. The exact nature of the data provided by the data 13 may vary with respect to the composite products that are to be modelled.

FIG. 3 illustrates an example of a user interface 15 that may be provided by software operating at the client device 2 to allow a user of the client device 2 to select schematic symbols 9 for inclusion in the schematic 11. In particular, the user interface 15 allows a user of the client device 2 to create a schematic representation of a manifold for regulating fluid flow, by selecting from a plurality of schematic symbols representing manifold modules such as valves, take offs, etc. In FIG. 3, a plurality of schematic symbols 16 each representing a respective manifold module is arranged in a left-hand portion of the user interface 15. The schematic symbols 16 are selectable by a user for inclusion in a schematic representation 17 of the manifold displayed in a right-hand portion of the user interface 15.

Respective markers 18, 19 indicate positions within the schematic representation 17 at which modules may be validly added to the manifold. A top portion 29 of the user interface 15 provides a plurality of controls for setting parameters that apply to the whole of the manifold. In particular, a “base” option 29a allows a base size to be selected, a “port size” option 29b allows a port size to be selected, while an “auto spacers” option 29c allows a user to select whether spacers (for placement between modules) are to be selected and placed manually, or to be placed automatically.

As will be known to the skilled person, some modules included within a manifold may be “inverted”. The user interface 15 therefore allows a user to indicate inversion for those schematic symbols that represent modules that may be inverted. For example, an orientation of a schematic symbol may be altered to indicate that the schematic symbol represents an inverted module.

The schematic representation 17 indicates a structure that manifolds may have. In particular, schematic symbols 20, 21, 22, 23, 24 and 25 may be considered to represent “inline” modules, while schematic symbols 26 to 28 may be considered to represent “stacker” modules. Inline modules may be considered to be defined in a left to right direction, while stacker modules form stacks above one or more inline modules. The schematic symbols 20-25 may therefore be referred to as inline symbols, while the schematic symbols 20-25 may be referred to as stacker symbols.

When the schematic representation 17 represents a manifold that a user wishes to model, the schematic representation 17 may be saved to provide the schematic 11. The schematic 11 may then be transmitted to the processing device 3 for processing. The schematic 11 may store the schematic representation in any appropriate format, as would be readily apparent to the skilled person. In some embodiments, the schematic 11 is stored in a format in which the position of each schematic symbol is defined with reference to its immediately neighbouring schematic symbols.

For example, with reference to FIG. 3, the schematic symbol 20 is defined as a root (or first) module. The schematic symbol 21 is defined as being to the right of the schematic symbol 20, the schematic symbol 22 is defined as being to the right of the schematic symbol 21, a schematic symbol 23 is defined as being to the right of the schematic symbol 22 and a schematic symbol 24 is defined as being to the right of the schematic symbol 23 and the schematic symbol 25 is defined as being to the right of the schematic symbol 24. The schematic symbol 26 is defined as being above the schematic symbol 24, the schematic symbol 27 is defined as being above the schematic symbol 26, and a schematic symbol 28 is defined as being above the schematic symbol 27.

In this way, operations to process respective symbols within the schematic 11 are easily defined. For example, directional operations may be provided, so that a user can step “right”, “left”, “up” or “down” from each module to determine the modules neighbouring a currently selected module.

FIG. 4 illustrates an example of a model 12 generated by the processing device 3 by processing a schematic 11. Modules corresponding to each respective schematic symbol 20 to 28 are provided within the model in an appropriate orientation together with any requisite components not specified in the schematic. An example of processing that may be performed to generate the model 12 is now described with reference to FIGS. 5 to 9.

In FIG. 5 logical components used in the processing of the schematic 11 to generate the model 12 are depicted. In particular, example classes used within a computer program that generates a model from a schematic are shown. A Job class 30 comprises data structures necessary for storing a schematic 11 and operations (e.g. sub-routines, methods, functions, etc) used for accessing the schematic symbols within the schematic. Each instance of the Job class 30 comprises a respective instance of a SchematicSymbol class 31 for each one of the schematic symbols present within the schematic 11. The instance of the Job class 30 comprises data items for defining a root symbol from amongst its instances of the SchematicSymbol class 31 and for storing information relating to the schematic 11 as a whole, such as a base type, a port size, etc. Each instance of the Job class 30 therefore provides a complete representation of a schematic for processing by the processing device 3.

Each instance of the Job class 30 is associated with an instance of a Model class 32. The Model class 32 comprises data structures suitable for storing the complete model 12, including a representation of the various modules and components of the composite product, and any other information that may be used to define the composite product such as a weight, length, height, etc. A ManifoldAssembler class 33 comprises operations (e.g. sub-routines, methods, functions, etc) and data items used to generate the model 12 from a schematic 11. In particular, the ManifoldAssembler class 33 comprises a primary sub-routine which is arranged to receive an instance of the Model class 32. The ManifoldAssembler class 33 is configured to process the instance of the Job class 30 associated with the received instance of the Model class 32 by stepping through the instances of the SchematicSymbol class 31 contained within the instance of the Job class 30. For each instance of the SchematicSymbol class 31 contained within the Job class 30, the ManifoldAssembler class 33 is configured to add appropriate modules and/or other components to the instance of the Model class 32 to generate the model 12.

Processing carried out by the primary sub-routine of the ManifoldAssembler class 33 is now described with reference to FIG. 6. It will be appreciated that in other embodiments of the invention, the processing of FIG. 6 may be performed at the client device 2. That is, in some embodiments, the processing device 3 and the client device 2 may be the same device.

At step S1 of FIG. 6 a schematic 11 is received and a new manifold model is created (e.g. an instance of the Model class 32 is instantiated together with an instance of the Job class 30). Processing passes from step S1 to step S2 at which an initial bracket is added to the model. In general, brackets may be required for attaching a manifold to a base. Where brackets are required, the number of brackets may be influenced by a number of factors, including the type of base to which the manifold will be attached (for example, a “Namur” base, a “1 inch” base, etc) and the number of modules that make up the manifold. For example, it may be specified that a bracket is required for every four modules of a manifold and that a manifold must have a minimum of two brackets in total. Respective counts may therefore be maintained of the number of modules that have been added to the manifold model since the last bracket was added, and the total number of brackets added to the manifold model.

Processing passes from step S2 to step S3 at which the root schematic symbol of the schematic 11 is made the current inline symbol. Processing then passes to step S4, at which a module represented by the current inline symbol is determined and that module added to the manifold model. Processing performed to select and add a module to the manifold model at step S4 is described in more detail below with reference to FIG. 7.

Processing passes from step S4 to step S5 at which it is determined whether an exhaust is associated with the module represented by the current inline symbol. The determination as to whether an exhaust module is required may be made in any appropriate way. For example, identification of those modules that require an exhaust may be made based upon an identifier provided within a name of the schematic symbol. In this way, the name of the current schematic symbol may be examined at step S5 to determine whether an exhaust module is required. For example, a specific character may be reserved for the names of symbols which represent modules that require exhausts.

If it is determined at step S5 that an exhaust module is required for the module added to the manifold model at step S4, processing passes to step S6 at which an exhaust module is added to the manifold model. Processing passes from step S6 to step S7. If, on the other hand, it is determined at step S5 that an exhaust module is not required in association with the module added to the manifold model at step S4, processing passes directly from step S5 to step S7.

At step S7 it is determined whether there is a stacker symbol “above” the current inline symbol in the schematic 11 (i.e. whether there are any stacker modules above the module that was added at step S4). If it is determined that there is a stacker symbol above the current inline symbol, processing passes from step S7 to step S8, at which the first stacker symbol in the stack is made the current stacker symbol. Processing passes from step S8 to step S9 at which a stacker module represented by the current stacker symbol is added to the manifold model.

Processing passes from step S9 to step S10 at which it is determined whether there is a stacker symbol above the current stacker symbol. If it is determined that there are stacker symbols above the current stacker symbol, processing passes to step S11 at which the next stacker symbol in the stack is set to be the current stacker symbol. Processing passes from step S11 to step S9. If, on the other hand, it is determined at step S10 that there are no stacker symbols above the current stacker symbol, processing passes to step S12.

At step S12 tie-rods are added to the manifold model for the current stack. A plurality of tie-rods run through each stacker module of the stack in order to fix the modules of the stack together. For example, a respective tie-rod may run through each of four “corners” of a stack. The length of the tie-rods to be used to connect the stack depends on the number and type (and therefore height) of stacker modules in the stack. By waiting until each stacker module has been processed, therefore, the correct tie-rod length can be automatically selected, and tie-rods of the correct length added.

Processing passes from step S12 to step S13. On the other hand, if it is determined at step S7 that there are no stacker symbols (and therefore no stack) above the current inline symbol, processing passes directly from step S7 to step S13. At step S13 it is determined whether further brackets are required to be added to the manifold model. As indicated above, a count may be maintained of the number of modules that have been added to the manifold model 12 since the last bracket was added. The determination at step S13 may therefore be a determination as to whether the count has reached a predetermined number (e.g. four). If it is determined at step S13 that a further bracket is required, processing passes to step S14 at which a bracket with an integrated seal is added to the manifold model. Processing passes from step S14 to step S16. On the other hand, if it is determined at step S13 that a further bracket is not required, processing passes from step S13 to step S15 at which a seal plate is added to the model after the previously added module. Processing passes from step S15 to step S16.

At step S16 it is determined whether there are any schematic symbols to the right of the current inline symbol. If it is determined that there are schematic symbols to the right of the current inline symbol, processing passes to step S17 at which the next inline symbol is made the current inline symbol. Processing passes from step S17 to step S4. If, on the other hand, it is determined at step S16 that there are no further schematic symbols to the right of the current inline symbol, processing passes from step S16 to step S18 at which any required inlet and outlet ports are added to the manifold model. Horizontal tie-rods tying the inline modules together are added based on the number and type (and therefore length) of modules added to the manifold model 12. The processing of FIG. 6 passes from step S18 to end at step S19.

It will be appreciated that the processing described with reference to FIG. 6 is an example of processing for generating a manifold model, in order to show how schematic symbols may be processed to generate a model of a composite product. Changes to the processing of FIG. 6 may be made both for generating models of manifolds, or for generating models of other types of composite product. For example, the processing of FIG. 6 assumes that brackets are added to the model. It may be that because of factors such as a particular base being used, brackets are not required, and would therefore not be added to the model 12 during the processing of the schematic 11.

It is described above that at steps S4 and S9 of FIG. 6 that inline modules and stacker modules respectively are added to the manifold model based on the current inline symbol or current stacker symbol being processed. Selection of the correct module is based on data stored in the database 5 in connection with each model. Referring to FIG. 7, processing carried out to add a new module to the manifold model at steps S4 and S9 is now described.

At a step S20 details of the module corresponding to the current inline or stacker symbol are obtained from a Modules table of the database 5 storing details of all modules. For example, each schematic symbol in the schematic 11 may comprise a respective identifier that can be used to determine a module identifier. The module identifier may then be used as an index into the Modules table. Where a schematic symbol represents a module that can be inverted, the schematic identifier of that schematic symbol may be associated with two module identifiers. The particular module identifier retrieved at step S20 may therefore include a determination of an orientation of the schematic symbol to determine whether the schematic symbol has been inverted.

The details obtained from the database 5 may include any details stored in the database 5 used to add the module to the manifold model (e.g. at a correct orientation and in a way that avoids conflicts between components). In the presently described example, the database 5 includes a 3D graphical representation of each module, orientation data for each module to allow the module (and the 3D graphical representation) to be correctly positioned in 3D space with respect to other modules, and to allow inlets of one module to align with outlets of a neighbouring module. The database 5 further comprises measurement information indicating amounts by which the current module (i.e. the module currently being added to the manifold model) protrudes into a space that is occupied by a previously added module and a space that may be occupied by a further module.

FIG. 8 schematically illustrates an example of protrusion data that may be stored for each module. A module 40 is schematically illustrated, the module 40 comprising a front face 41, a top face 42, a bottom face 43 (not visible), a left face 44, a right face 45 (not visible) and a back face 46 (not visible). For a manifold such as the manifold shown in FIG. 4, it may be desired to process a top, bottom and front face of each module as these are the faces from which protrusions may occur (the back, left and right faces being generally utilised for connection with a base and other with modules).

An arrow 47 protruding from the front face 41 indicates a protrusion perpendicular to the front face 41. A size of the front protrusion is stored in a FrontProtrusion field of the Modules table of the database 5. An arrow 48 indicates an amount by which the front protrusion 47 extends leftward into a region that may be occupied by a previous module (e.g. beyond a main body of the module 40). A size of the leftward protrusion 48 is stored in an InvadeByFrontLeft field of the Modules table of the database 5. An arrow 49 indicates an amount by which the front protrusion 47 extends rightward into a region that may be occupied by a following module (e.g. beyond a main body of the module 40). A size of the rightward protrusion 49 is stored in an InvadeByFrontRight field of the Modules table of the database 5.

An arrow 50 indicates a top protrusion perpendicular to the top face 42. An arrow 51 indicates an amount by which the top protrusion 50 extends leftward into a region that may be occupied by a previous module. A size of the leftward protrusion 51 is stored in an InvadeByTopLeft field of the Modules table of the database 5. An arrow 52 indicates an amount by which the top protrusion 50 extends rightward into a region that may be occupied by a following module. A size of the rightward protrusion 52 is stored in an InvadeByTopRight field of the Modules table of the database 5.

Similar information as described above for the front face 41 and top face 42 may be stored for the bottom face 43 in a BottomProtrusion field, an InvadeByBottomLeft field and an InvadeByBottomRight field of the Modules table of the database 5. It is to be understood, however, that the protrusion information illustrated in FIG. 8 is exemplary, and that additional or different protrusion information may be stored in dependence upon the type of modules to be modelled. That is, any protrusion information may be stored, for any area of a module.

With reference again to FIG. 4, the effect of protrusions on the placement of modules in a manifold may be more clearly appreciated. A module 60 comprises a port portion 61 that protrudes to the front of the module 61. A module 62 to the right of the module 60 comprises a handle portion 63 that also protrudes to the front. The handle portion 63 also protrudes to front-left and front-right of the module 62. It can be seen from FIG. 4 that the protrusions 60 and 63 are such that placement of the module 62 next to the module 60 could result in impingement of the handle portion 63 on the port portion 61, such that the ability to correctly operate the handle portion 63 would be compromised. It will be appreciated protrusion information may set for reasons other than a physical protrusion. That is, it may be determined that a clearance is required between components for any reason, and appropriate indications stored in the database 5 accordingly.

Referring again to FIG. 7, at step S21, the protrusion details of the current module are processed, in combination with the protrusion details of the previously added module to determine whether any additional space is required between the previously added module and the current module. The processing of step S21 is described in more detail below with reference to the flowchart shown in FIG. 9. At step S22 it is determined whether the amount of space required (if any) calculated at step S21 is such that one or more spacer components are required to be added to the model between the previous module and the current module.

If it is determined that one or more spacers are required, processing passes to step S23 at which one or more spacers are added to the model in accordance with the space requirements determined at step S21. For example, one or more spacer components may be defined as being available for use between modules, each spacer component having a predetermined amount by which that spacer component separates modules between which it is placed. Depending upon the size information calculated at step S21, one or more spacers may be selected as required.

Referring to FIG. 4, it can be seen that a spacer module 64 is placed between the module 60 and the module 62 such that the protrusions 61 and 63 do not impinge upon each-other. Referring again to FIG. 7, processing passes from step S23 to step S24. If, on the other hand, it is determined at step S22 that no spacers are required between the current module and the previous module, processing passes from step S22 directly to step S24.

At step S24 the module corresponding to the schematic symbol currently being processed is added to the model 12. As described above, the Modules table of the database 5 stores orientation information for each module so that each module can be appropriately oriented within the model 12 with respect to other components and so that inlets and outlets of adjacent modules correctly align. Different orientation, offset, and protrusion data may be stored for inverted and non-inverted modules to allow both inverted and non-inverted modules to be correctly processed.

Processing passes from step S24 to step S25 at which height and/or length parameters are updated to allow the calculation of appropriate tie-rod lengths at steps S12 and/or S18.

The processing described above in connection with FIG. 7 is described in terms of modules added to the model 12 in a single “piece”. It will be appreciated, however, that modules may comprise a plurality of separate pieces. For example, FIG. 10 illustrates a Double ½ inch Take-off Module 60 comprising a first ½ inch Port Block 61, a first Seal Plate 62, a Double Take-off Body 63, a second Seal Plate 64 and a second ½ inch Port Block 65. An entry may be stored in the database 5 for each respective piece with a module comprising a “base piece” and with other pieces of the module having a defined offset from the location of the base piece within the model. Locations of module “faces” and protrusions therefrom (as described in more detail below) may be stored per module, rather than per-piece.

Referring to FIG. 9, processing carried out to calculate a required number of spacers is now described. At step S30 a current module face to be processed is selected. The processing at step S30 may select, for example, the top face. Processing passes from step S30 to step S31 at which it is determined whether there are protrusions from the selected face on each of the previous and the current modules. For example, if the top face was selected at step S30, it is determined at step S31 whether there is a top protrusion on the previously added module and a top protrusion on the module currently being processed.

If it is determined at step S31 that there is a protrusion on each of the previous and the current module for the currently selected face, processing passes to step S32 at which a spacing value required to accommodate the protrusions from the face being processed is set to be equal to the amount by which the previous module protrudes into the space occupied by the current module plus the amount that the current module protrudes into the space occupied by the previous module. That is, with reference to the protrusion values stored in the Modules table of the database 5, the spacing required to accommodate the protrusions from the top face would be set to be equal to the value stored in the InvadeByTopRight field for the previous module plus the value stored in the InvadeByTopLeft field for the current module.

Processing passes from step S32 to step S33 at which it is determined whether there are further faces to be processed. If it is determined that there are further faces to be processed, processing passes to step S34 at which the next face (e.g. the bottom face, or front face) is set to be the next face for processing. Processing passes from step S34 to step S31.

If it is determined at step S31 that either of the previous or the current modules do not comprise protrusions from the face currently being processed, processing passes directly from step S31 to step S33.

If it is determined at step S33 that there are no further faces to be processed, processing passes from step S33 to step S35 at which the spacing required between the previous and current modules is set to be the largest of the spacing values calculated for each of the faces. That is, if the spacing calculated to be needed to accommodate protrusions from the top face is larger than the spacing calculated to be required to accommodate protrusions from the bottom face and larger than the spacing calculated to be required to accommodate protrusions from the front face, the overall required spacing would be determined at step S35 to be the spacing value calculated for the top face. Similarly, if the spacing value calculated for the bottom face is the largest spacing value, the overall spacing value required would be determined at step S35 to be the spacing value calculated for the bottom face. Finally, if the spacing value calculated for the front face is the largest spacing value, the overall spacing value required would be determined at step S35 to be the spacing value calculated for the front face.

The processing described above with reference to FIGS. 6, 7 and 9 has described example processing that may be carried out to add particular modules to a model of a manifold. It will be appreciated that other processing may be required depending upon the characteristics of the modules that are to be added to the manifold, and the characteristics of the manifold itself.

It will be appreciated from the above that the processing of FIGS. 6, 7 and 9 allows for the creation of a detailed model 12 of a manifold based on a simple, easily generated schematic 11. The model 12 may be saved in any appropriate format and used to accurately determine whether the manifold modelled therein meets predetermined requirements, such as space requirements. For example, the model 12 may be used to generate a 3D visualisation of the manifold.

If such modelling results in a determination that a manifold design does not meet one or more requirements, it will be appreciated that changes may be easily made to the schematic 11 using, for example, the user interface 15 to add, remove or replace schematic symbols. A new model may then be created. Embodiments described herein therefore also allow for a rapid reconfiguration of information used to generate models of composite products such as manifolds, and the rapid generation of models in accordance with that information.

Models generated according to embodiments described herein may be used to construct a composite products in accordance with those models.

The detailed examples described above have been concerned with the generation of models of composite products in the form of manifolds for regulating fluid flow. It will be appreciated that other embodiments are not limited to the generation of models of manifolds, but rather allow the generation of models for other composite products.

Referring to FIG. 11 there is shown an exemplary schematic illustration of an arrangement 70 of components which can be used to provide the processing device 3 in accordance with some embodiments described herein. It can be seen that the arrangement 70 comprises a CPU 71 which is configured to read and execute instructions stored in a volatile memory 72 which takes the form of a random access memory. The volatile memory 72 stores instructions for execution by the CPU 71 and data used by those instructions. For example, where the arrangement 70 is used to implement the processing device 3, instructions for providing the web-application to the client 2, and for processing a received schematic to generate a model may be loaded into and stored in the volatile memory 72.

The arrangement 70 further comprises non-volatile storage 73. The non-volatile storage may be implemented in any appropriate way, such as, for example, a hard disk drive (HDD) or a solid state drive (SSD). The non-volatile storage may store the database 5. Computer readable instructions for causing the processing device 3 to provide a web-application to the client 2, and for processing a received schematic to generate a model, may be stored in the non-volatile storage 73. The arrangement 70 further comprises an I/O interface 74 to which are connected peripheral devices used in connection with the processing device 3. More particularly, a display 75 is configured so as to display output from the processing device 3. Input devices are also connected to the I/O interface 74. Such input devices include a keyboard 76 and a mouse 77 which allow user interaction with the arrangement 70. A network interface 78 allows the processing device 3 to be connected to appropriate computer networks, such as the network 4, so as to receive and transmit data from and to other computing devices such as the client 2. The CPU 71, volatile memory 72, non-volatile storage 73, I/O interface 74, and network interface 78, are connected together by a bus 79.

It will be appreciated that the arrangement of components illustrated in FIG. 11 is merely exemplary, and that the processing device 3 may comprise additional or fewer components than those illustrated in FIG. 11. Indeed, the processing device 3 may comprise a plurality of computers, similar to, or arranged differently from, the arrangement 70. For example, the processing device 3 may comprise a plurality of computers respectively adapted to provide, inter alia, a web server, an application server, a gateway server and a database server etc to provide web-applications to the client device 2 over the network 4. That is, it is to be understood that the arrangement 70 may be implemented using any appropriate configuration as will be readily appreciated by those skilled in the art. It will also be appreciated that the client device 2 may each comprise an arrangement of components similar to the arrangement 70, or again using any appropriate configuration.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims that follow.

1. A computer implemented method of generating a model of a composite product comprising a plurality of modules, comprising:
receiving a schematic comprising a plurality of schematic symbols, each schematic symbol representing a respective module; and
processing each schematic symbol in turn, the processing comprising:
determining a module represented by the schematic symbol,
determining one or more module requirements for the module represented by the schematic symbol; and
adding a representation of the module to a model in accordance with the module requirements.

2. A method according to claim 1, wherein the modules are adjacent one another and determining one or more module requirements for at least some of the schematic symbols comprises determining module requirements relating to an adjacent module.

3. A method according to claim 1, wherein determining one or more module requirements comprises determining a spacing requirement indicating a spacing required between the module and another module.

4. A method according to claim 3, further comprising adding a representation of a spacer component to the model between the module and said another module in dependence upon the determined spacing requirement.

5. A method according to claim 1, wherein determining one or more module requirements comprises determining one or more first components required in combination with the module.

6. A method according to claim 5, wherein adding a representation of the module to the model further comprises adding representations of said one or more first components to the model.

7. A method according to claim 1, wherein the representation of the module comprises data indicating physical characteristics of the module.

8. A method according to claim 7, wherein said data comprising physical characteristics of the module comprises a 3D graphical representation of the module.

9. A method according to claim 8, further comprising outputting a 3D graphical representation of the composite product.

10. A method according to claim 1, further comprising determining one or more second components required in the composite product as a result of at least one of the modules represented in the model; and
adding a representation of the one or more second components to the model.

11. A method according to claim 1, wherein each schematic symbol comprises a respective symbol identifier and wherein determining a module represented by a schematic symbol comprises obtaining a module identifier associated with the symbol identifier.

12. A method according to claim 11, wherein determining one or more module requirements for the module represented by the schematic symbol comprises determining one or more module requirements stored in a database and associated with the module identifier.

13. A method according to claim 11, wherein obtaining a module identifier associated with the symbol identifier comprises determining an orientation of the schematic symbol.

14. A method according to claim 1, wherein the composite product is a manifold.

15. An apparatus for generating a model of a composite product comprising a plurality of modules, the apparatus comprising:
a receiver arranged to receive a schematic comprising a plurality of schematic symbols, each schematic symbol representing a respective module; and
a processor arranged to process each schematic symbol in turn to:
determine a module represented by the schematic symbol;
determine one or more module requirements for the module represented by the schematic symbol, and
add a representation of the module to a model in accordance with the module requirements.

16. A computer implemented method comprising:
at a first computer providing a web-based application to a client computer over a network, the web-based application providing a user interface, the user interface being configured to receive a selection from a plurality of schematic symbols, each schematic symbol representing one of a plurality of modules, to receive indications of associations between the selected schematic symbols;
the web-based application being configured to generate a schematic representing a composite product based on the received selection and the received indications and to transmit the schematic to a computer configured to perform the operations of:
receiving a schematic comprising a plurality of schematic symbols, each schematic symbol representing a respective module;
processing each schematic symbol in turn, the processing comprising:
determining a module represented by the schematic symbol;
determining one or more module requirements for the module represented by the schematic symbol; and
adding a representation of the module to a model in accordance with the module requirements.

17. The computer implemented method of claim 16, further comprising at the client computer:
receiving at the user interface from the user a selection from the plurality of schematic symbols;
receiving at the user interface from the user indications of associations between the selected schematic symbols; and
generating a schematic representing a composite product based on the received selection and the received indications.

18. (canceled)

19. (canceled)

20. (canceled)
